(19) United States
(12) Patent Application Publication
(10) Pub. No.: US 2019/0382986 A1
(43) Pub. Date: Dec. 19, 2019

(54) WATER OUTLET FITTING WITH DRINKING WATER FILTER

(71) Applicant: Franke Technology and Trademark Ltd, Hergiswil (CH)

(72) Inventors: Markus Leutwiler, Villmergen (CH); Roland Gloor, Zetzwil (CH); Christoph Kellenberger, Zurich (CH); Michael Loepfe, Zurich (CH)

(73) Assignee: Franke Technology and Trademark Ltd, Hergiswil (CH)

(21) Appl. No.: 16/442,938

(22) Filed: Jun. 17, 2019

(30) Foreign Application Priority Data
Jun. 18, 2018 (DE) 102018114581.0

(51) Int. Cl. E03B 7/07; E03C 1/04; B01D 35/04; C02F 1/00

(52) U.S. Cl. CPC E03B 7/074; E03C 1/04; B01D 35/04; C02F 2201/006; E03C 2201/40; C02F 2307/06; C02F 1/003

(57) ABSTRACT

A multifunctional water outlet fitting for selectively dispensing service water and filtered drinking water has a fitting member having at least one water supply, a first outlet for service water which branches off from the fitting member, a second outlet for filtered drinking water which branches off from the fitting member and, for a drinking water filter, a filter receiving space through which water can flow connected to the second outlet so as to carry water. The filter receiving space is formed by a filter housing which is arranged at the end of the second outlet facing away from the fitting member, and the filter housing has a downwardly facing base in which there is formed a mouth opening, from which filtered drinking water can be removed. The filtered drinking water is consequently removed directly from the filter housing so that any formation of germs in a connected waterway is prevented.

### INCORPORATION BY REFERENCE

The following documents are incorporated herein by reference as if fully set forth: German Patent Application No. 10 2018 114 581.0, filed Jun. 18, 2018.

### BACKGROUND

The present invention relates to a multifunctional water outlet fitting which is for selectively dispensing service water and filtered drinking water and which has a fitting member having at least one water supply, a first outlet for service water which branches off from the fitting member, a second outlet for filtered drinking water which branches off from the fitting member and, for a drinking water filter, a filter receiving space through which water can flow and which is connected to the second outlet so as to carry water.

In many regions, the quality of the water from the public water supply or from a domestic water supply does not comply with the hygiene requirements for drinking water. In this instance, drinking water filters can be used in order to filter out impurities contained in the service water. There are known for this purpose filter attachments which can be retrofitted and which are screwed or placed on the mouth opening of the water outlet of a fitting and which contain a corresponding drinking water filter. Such filter attachments which can be retrofitted are, for example, described in the documents EP 798424 A2, JP 2002/310357, JP 2002/331298 A, WO 1999/037375 A1 or WO/199/029391 A1. Such attachment filters which are fitted on the outlet of a fitting are, however, bulky and thereby impractical and are in normal use in the way of the fitting, such as, for example, when taking service water for rinsing or washing hands.

There are known in addition fittings which have an integrated drinking water filter. For example, EP 2 249 942 B1 sets out a fitting with a filter integrated in the fitting member. The document US 2014/0215709 A1 describes a fitting with a separate discharge on the fitting member, on which there can be placed an upwardly facing filter cartridge, on which a separate outlet for filtered water is fitted. Via this fitting, it is consequently possible to selectively remove service water and filtered drinking water.

The fitting described in WO 2013/044339 A1 also has a filter which is received in the fitting body. There are arranged on the fitting body two outlets from which service water and filtered drinking water can be selectively removed. WO 2012/029412 A1 also schematically shows a fitting having an outlet for service water, a filter and a separate outlet which extends from the filter for filtered water.

The disadvantage of such fittings with an integrated drinking water filter is that behind the filter there follow in each case water-carrying components of the fitting, such as in particular valves, a tubular outlet, or waterways which are formed in the fitting body and in which germs can accumulate and contaminate the filtered water. Such a build-up of germs within the fitting may in particular be problematic in warm regions. Filtered drinking water could therefore become contaminated with germs behind the filter in an undetected manner.

### SUMMARY

An object of the present invention is therefore to provide a water outlet fitting which is for selectively dispensing service water and filtered drinking water and which is improved, on the one hand, with respect to operability, on the other hand, with regard to hygiene and safety.

The object is achieved by a water outlet fitting with one or more features of the invention. Advantageous embodiments are described below and in the claims.

With a water outlet fitting of the type mentioned in the introduction, there is provision according to the invention for the filter receiving space to be formed by a filter housing which is arranged at the end of the second outlet facing away from the fitting member, and for the filter housing to have a downwardly facing base in which there is formed a mouth opening, from which filtered drinking water can be removed. According to the present invention, there is consequently provision for the filtered drinking water to flow directly out of the filter housing and to be removed so that any formation of germs in a connected waterway is prevented.

In a preferred embodiment, there is provision for the filter housing to be constructed as a preferably cylindrical housing with a cross-section which is increased compared with the second outlet and in whose upper region the second outlet opens. The filter housing is consequently flowed through in a substantially vertical direction and provides sufficient space for receiving a filter cartridge.

The filter housing is preferably constructed in a cylindrical manner such that water flows round from the second outlet into an outer annular space, flows through a cylindrical filter cartridge which is inserted in the filter housing and is discharged in an axial direction centrally from the mouth opening formed in the base of the filter housing. The radially symmetrical, in particular cylindrical shape of the filter cartridge and filter housing is preferred since in this instance the filter cartridge is subjected to flow from the outer side and the filtered water can be removed directly from the axial inner space of the filter. The complete outer side of the filter cartridge which is touched, for example, during insertion and is consequently subjected to contamination consequently represents the “unclean” side of the filter, while the clean side of the filter inside the filter cartridge is protected from environmental influences and contamination.

In another embodiment, there is provision for a closure valve for blocking and releasing a discharge of filtered water to be arranged between the second outlet and the filter housing. Such a closure valve may in particular be arranged directly on the filter housing in the upper supply-side region thereof. The filter housing or a securing base which is provided for the filter housing on the second outlet provides sufficient space to additionally receive a corresponding valve cartridge in addition to a filter cartridge. On the fitting member, it is consequently not necessary to provide two separate closure valves for service water and filtered drinking water or a corresponding diverter, which facilitates the operation of the fitting. The closure valve on the filter housing is consequently also clearly associated with the function of dispensing filtered drinking water, which makes the fitting easy to operate in an intuitive manner.

In another embodiment, there may be arranged between the second outlet and the filter housing—additionally or alternatively to a closure valve—a non-return valve having a blocking element, which is retained in an open position by a filter cartridge which is inserted in the filter housing and in which a waterway from the second outlet into the filter housing is released and which in the absence of a filter cartridge is moved under the action of a closure spring or the water pressure into a closure position, in which it blocks the waterway between the second outlet and filter housing. Such a non-return valve prevents, on the one hand, when the filter housing is opened, for example, in order to replace the filter cartridge, water from being able to flow out. Furthermore, the non-return valve prevents water from being able to be removed in the absence of a filter cartridge. The outlet function for filtered drinking water is consequently blocked as long as no filter cartridge is inserted so that a user cannot unintentionally, trusting that a filter cartridge is present, remove unfiltered water as drinking water.

The filter housing can be opened or removed in order to replace and insert a filter. Preferably for this purpose, the filter housing may be provided with a screw or bayonet closure by which it is retained on a downwardly facing receiving base at the end of the second outlet remote from the fitting member. This enables simple and user-friendly replacement of the drinking water filter.

In order to improve the operability and flexibility of the fitting, there may preferably be provision for the second outlet to be able to be pivoted relative to the fitting member. It can consequently be pivoted into a position in which, for example, when the fitting is washed or otherwise used, it is not in the way of the first outlet for service water.

The second outlet may be rotatably connected to the fitting member in particular via an annular shoulder which is formed concentrically around the first outlet.

A valve insert with a valve for controlling a water flow of service water from the first outlet is advantageously provided on the fitting member. The fitting member has in this instance a first waterway from the valve to the first outlet and a second waterway from the water supply to the second outlet, with the valve being bypassed. Consequently, at the fitting member the service water can be turned on and off in conventional manner. Drinking water in contrast is drawn off directly at the filter housing which for this purpose is provided with a separate valve.

The valve insert on the fitting member may in particular be constructed as a mixing valve. The fitting consequently has a hot water supply and a cold water supply which lead to the mixing valve. The first waterway consequently guides mixed water from the mixing valve. However, the second waterway branches directly off from the cold water supply and guides cold water. Alternatively, it is also possible to construct the fitting with a third water supply via which water is supplied, for example, from a cooling device arranged under the operating plate and is discharged via the second outlet as cooled and filtered water.

In another embodiment of the invention, an electronic counter device is integrated in the filter housing and in the filter housing there is arranged an optical display which is connected to the counter device and which displays a functional state of a filter inserted in the filter housing. Since the filter insert generally becomes worn out or unusable after a specific period of use, it can consequently be ensured that it is indicated to the user promptly that a new filter insert should be inserted. The counter device may in particular comprise a throughflow meter so that in accordance with the quantity of filtered drinking water drawn off a replacement of the filter cartridge can be indicated. Alternatively, only a timer which signals a filter replacement in each case after a predetermined period of time has elapsed may also be provided.

As a particularly preferred measure in the context of the present invention, there is provision for the mouth opening on the base of the filter housing to receive a mouthpiece which is arranged on the filter and from which filtered water is discharged from the filter. By water being discharged from a mouthpiece which is arranged on the filter, any contact of the filtered water at the “clean” side of the filter cartridge with any components of the fitting is excluded so that recontamination of the filtered water downstream of the filter is impossible.

The mouthpiece which is arranged on the filter may in the delivery state be sealed in a sterile manner by a tear-off film. This film is removed only when the filter is inserted into the filter housing. Consequently, the hygienically sound state of the filter is ensured.

It is further preferable for the mouthpiece additionally to comprise an integrated jet controller. Such a jet controller is generally arranged on the outlet of a fitting and ensures that the water is discharged with the desired jet characteristics, where applicable aerated, from the outlet. Such a jet controller is as a result of construction particularly susceptible to the accumulation of contamination and may represent a source of germ formation inside the fitting. By this jet controller being constructed so as to be integrated with the filter cartridge as a single-use article, it is no longer a source for germ formation without having to dispense with the comfort function which is connected with a jet controller.

### BRIEF DESCRIPTION OF THE DRAWINGS

Other advantages and embodiments of the present invention will be appreciated from the following description of preferred embodiments with reference to the Figures, in which:

FIG. 1 is an isometric illustration of a water outlet fitting with separate outlets for service water and filtered drinking water,

FIG. 2 is a section through a filter housing and outlet for filtered water of the fitting from FIG. 1,

FIG. 3 is an exploded illustration of the filter housing from FIG. 2,

FIG. 4A is a detailed section through a non-return valve which is provided in the filter housing,

FIG. 4B shows the non-return valve from FIG. 4A with the filter removed,

FIG. 5 is a section through the filter housing and the filter outlet in a second embodiment, and

FIG. 6 is an isometric illustration of a filter cartridge which can be used in the second embodiment.

### DETAILED DESCRIPTION

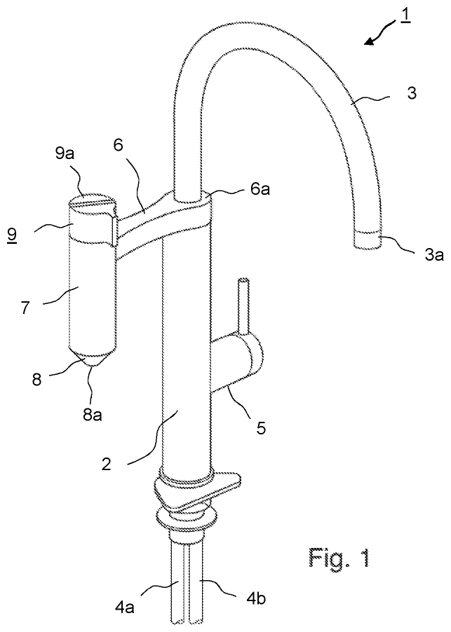

The water outlet fitting 1 shown in FIG. 1 comprises a fitting member 2 which is screwed to an operating plate or a kitchen sink. There extends in an upward direction from the fitting member 2 a curved water outlet 3 with a mouthpiece 3a of conventional construction type, for example, a jet controller. The water outlet 3 acts as an outlet for service water. Service water in the context of the invention is intended to be understood to be hot water, cold water or mixed water, as drawn from the public water supply or a domestic water supply but which has no or questionable drinking water quality.

The water outlet fitting 1 has two supply lines 4a, 4b for hot water and cold water and a single-lever mixing valve 5 having a corresponding valve insert by which the supplied hot and cold water is mixed and can be discharged via the water outlet 3. Within the fitting member 2, consequently, waterways lead in a manner also known per se from the supply lines 4a, 4b to the mixing valve 5 and from there to the water outlet 3.

In the upper region of the fitting member 2, there branches off (in this instance, in a substantially horizontal manner, but without the invention being limited thereto) a second outlet line 6, at the end of which a filter housing 7 which faces perpendicularly downward is arranged. In the region of the branching, the outlet line 6 is constructed in the form of an annular shoulder 6a, which is located concentrically around the upwardly facing outlet line 3 and which can be pivoted about the center axis of the fitting body 2. A waterway for cold water extends at the inner side of the fitting member 2 to the shoulder 6a and opens at that location in an annular space which is formed inside the shoulder 6a and which is open at the peripheral side and which is sealed in a sliding manner with respect to the shoulder 6a and via which the water reaches the second outlet 6.

It would also be possible to provide a separate third water supply connection (not shown) on the lower side of the fitting member 2, which corresponds via a waterway within the fitting member 2 with the outlet 6. Such a third supply connection is, for example, advantageous when the drinking water discharged via the water filter is intended to be precooled beforehand in a cooler installed below the operating plate. If, in this instance, the fitting is installed without any cooler, the supply connection for cold water and the third supply connection which corresponds to the filter outlet can be connected in a simple manner below an operating plate via a separate T-piece to the supply line for cold water.

The filter housing 7 is constructed in a substantially cylindrical manner and tapers conically in the direction toward the base 8 thereof. In the center of this tapered base region 8 is a mouth opening 8a, from which filtered drinking water can be discharged. To this end, a valve 9 with a rotary handle 9a is arranged in the upper region of the filter housing 7. If this valve 9 is opened, water flows via the outlet line 6 into an outer annular region 7a of the filter housing 7, flows through the drinking water filter which is inserted in the filter housing 7 and is axially discharged via the mouth opening 8a.

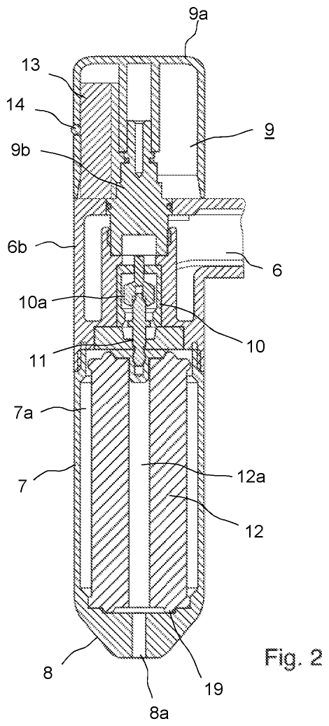

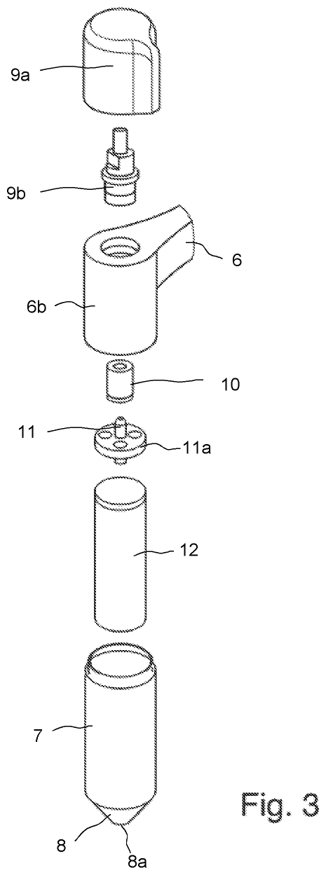

In FIG. 2, the filter housing 7 is illustrated so as to be enlarged as a longitudinal section. In the upper region, the closure valve 9 can be seen with the valve handle 9a thereof and a valve insert 9b which is located therebelow. By turning the valve handle 9a, a spindle of the valve insert 9b is activated and the valve 9 releases the waterway in the direction from the outlet line 6 into the valve housing 7.

Between the valve insert 9b and the valve housing 7 there is further located a non-return valve 10 having a closure member 10a which is retained by a confirmation pin 11 at the top in the open position thereof. The confirmation pin 11 in turn is retained at the top by a filter cartridge 12 which is inserted into the filter housing 7 so that the non-return valve 10 is open when the filter cartridge 12 is inserted and when the filter housing 7 is screwed on.

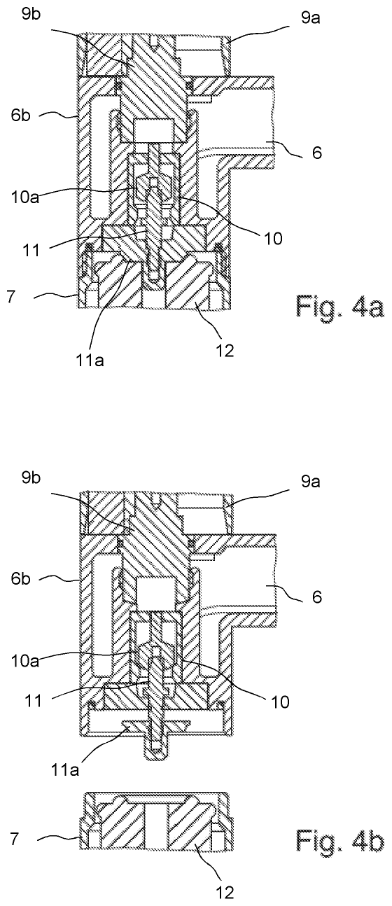

There is formed at the end of the water outlet line 6, a downwardly facing receiving base 6b for the filter housing 7, to which it is secured in a water-tight manner by a screw or bayonet closure. If the filter housing 7 is removed, in order to change the filter insert 12, as a result of the water pressure or alternatively a closure spring (not shown in this instance), the valve member 10a is moved downward into the closure position thereof so that no water can be discharged from the outlet 6. The opening position and closure position of the non-return valve with the valve cartridge inserted or removed are illustrated in FIGS. 4A and 4B to an enlarged scale again. It is possible to see in FIG. 4B in particular the confirmation pin 11 which is moved in the direction of the lower stop thereof with a confirmation plate 11a which moves into engagement in a corresponding recess 12a in the upper region of the filter cartridge 12 and which is retained at the top thereby when the filter cartridge 12, as shown in FIG. 4A, is inserted and screwed on by the filter housing 7.

During operation, water flows out of the outlet line 6 with the valve 9 open and the filter cartridge 12 inserted into an outer annular space 7a of the filter housing 7. From there, it flows though the filter material of the inserted filter cartridge 12 and reaches an axial hollow space 12a of the filter cartridge. From there, it flows via the mouth opening 8a in the base 8 of the filter housing 7 from the outlet of the fitting, for example, into a drinking vessel which has been placed below it by a user.

As an additional (optional) function, there is integrated in the valve cap 9a a battery-operated electrical circuit 13 which via a multi-colored LED 14 transmits information relating to the state of the filter insert 12. In the embodiment, the circuit 13 contains only a timer, which is reset after the filter cartridge 12 has been replaced and which after a preset operating time has elapsed for the filter cartridge 12 provides a reminder for replacement. However, it is alternatively or cumulatively also possible to use a throughflow meter which is arranged in the waterway, for example, in the form of an impeller counter so that a replacement of the filter cartridge 12 can be indicated in accordance with the filtered quantity of water. As long as the filter cartridge 12 is within the intended period of use thereof, the LED 14 flashes green (for example, every 5 seconds). After the intended period of use has elapsed, when a replacement of the filter cartridge 12 is thus recommended, the color of the LED 14 changes to red. If a replacement of the filter cartridge is overdue and the drinking quality of the filter water is consequently no longer ensured, as a warning the flashing frequency is additionally increased, for example, rapid flashing 1× per second.

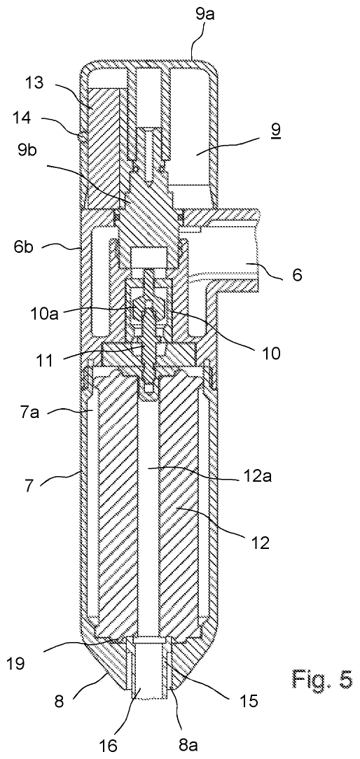

A second embodiment of the filter outlet with the filter housing 7 thereof is shown in FIG. 5. Components which are the same and which have the same effect are provided with the same reference numerals as in the first embodiment. The filter cartridge 12 has in the second embodiment at the lower end a collar 15 which is located around the axial hollow space 12a and which acts as a mouthpiece. The collar 15 is sized in such a manner that it passes through the mouth opening 8a in the base 8 of the filter housing 7, which opening is in this instance constructed to be larger. Inside the collar 15, a so-called jet controller 16 or aerator is arranged. This ensures that water from inside the filter cartridge 12 is formed into a water jet and discharged in a state mixed with air bubbles. By the aerator 16 and mouth opening with the collar which surrounds it or mouthpiece 15 being formed directly in an integral manner on the filter cartridge 12, in this instance any contact of water with the filter housing 7 or other line or fitting components after the filtering is excluded. The filter cartridge 12 and the integrated aerator 16 are configured as a single-use component and after an intended period of operation are replaced for reasons of hygiene. Consequently, the filtered water dispensed by the fitting is always hygienically sound.

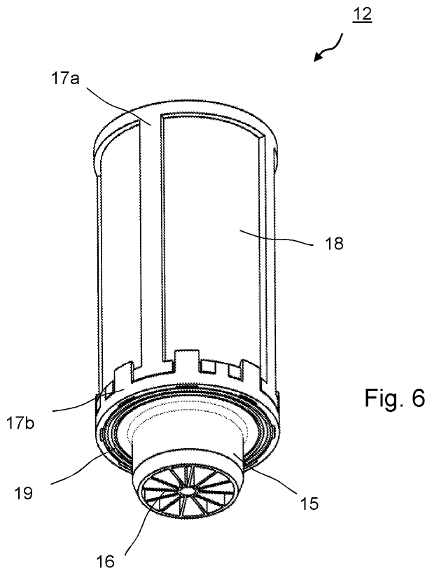

A filter cartridge 12 is illustrated in FIG. 6 by way of example. It comprises a skeletonized, two-part injection-molding housing 17a, 17b in which the covering face is extensively recessed as a filter-active face. The housing portions 17a, 17b are snap-fitted or locked to each other at the base side. The covering face of the cylindrical filter insert 12 is provided with a membrane 18 which is provided with nano-openings (nanopores). Such a “nano membrane” is, for example, described in the document WO 2012/097967 A1, to the whole content of which reference is hereby made in order to avoid unnecessary repetition. The nano-openings in the membrane ensure sufficient water passage. However, microparticles contained in the water, such as, for example, microbiological impurities, are retained.

In addition to the nanomembrane, the filter additionally comprises an outermost filter nonwoven as a prefilter for suspended solids, an internal activated carbon layer and preferably another layer with biologically active silver particles. This combination ensures a microbiologically sound, sterile filtering of drinking water. The upper end face of the cylindrical filter insert 12 is closed in a water-tight manner. It serves as already explained via the confirmation pin 11 to retain the non-return valve 10 in the open position. At the lower side, the filter insert 12 further has an annular seal 19 which is located around the mouthpiece 15 and which seals the filter cartridge 12 against the base 8 of the filter housing 7. Consequently, water which has flowed into the filter housing 7 from the outlet line 6 can reach the axial inner space 12a of the filter 12 after passing through the filter-active layers and from there can flow out through the mouthpiece 15 which is fitted to the filter.

1. A multifunctional water outlet fitting (1) configured to selectively dispensing service water and filtered drinking water, the multifunctional water outlet fitting (1) comprising:
a fitting member (2) having at least one water supply (4a, 4b);
a first outlet (3) for service water which branches off from the fitting member (2);
a second outlet (6) for filtered drinking water which branches off from the fitting member (2);
a drinking water filter (12);
a filter housing (7) which is arranged at the end of the second outlet (6) facing away from the fitting member (2) with a filter receiving space in the filter housing (7) in which the drinking water filter (12) is located through which water selectively flows and which is connected to the second outlet (6) so as to carry water;
the filter housing (7) has a downwardly facing base (8) in which there is formed a mouth opening (8a), from which filtered drinking water is selectively discharged;
a closure valve (9) configured to block or release a discharge of filtered water arranged between the second outlet (6) and the filter housing (7); and
a valve insert (5) with a valve for controlling a water flow of service water from the first outlet (3) provided on the fitting member (2), the fitting member (2) has a first waterway from the valve to the first outlet (3) and a second waterway from the water supply (4a) to the second outlet (6), with the valve being bypassed.

2. The water outlet fitting as claimed in claim 1, wherein the filter housing (7) comprises a cylindrical housing with a cross-section which larger in comparison to the second outlet (6) and in an upper region (6a) of which the second outlet (6) opens.

3. The water outlet fitting as claimed in claim 1, wherein the filter housing (7) is cylindrical and is configured such that service water flows from the second outlet (6) into an outer annular space (7a), flows through the drinking water filter (12) which is cylindrical and located in the filter receiving space, and is discharged in an axial direction centrally from a mouth opening (8a) in the base (8) of the filter housing (7).

4. The water outlet fitting as claimed in claim 1, further comprising a non-return valve (10) arranged between the second outlet (6) and the filter housing (7), the non-return valve (10) having a blocking element (10a) which is retained in an open position by the filter cartridge (12) which is inserted in the filter housing (7) such that a waterway from the second outlet (6) into the filter housing (7) is released and which is movable to a closure position if the filter cartridge (12) is not present via a closure spring or water pressure, in which the non-return valve (10) blocks the waterway between the second outlet (6) and filter housing (7).

5. The water outlet fitting as claimed in claim 1, wherein the filter housing (7) is openable or removable in order to replace and insert a new one of the filter cartridges.

6. The water outlet fitting as claimed in claim 1, wherein the filter housing (7) includes a screw or bayonet closure by which it is retained on a downwardly facing receiving base (6b) at an end of the second outlet (6) remote from the fitting member (2).

7. The water outlet fitting as claimed in claim 1, wherein the second outlet (6) is pivotable relative to the fitting member (2).

8. The water outlet fitting as claimed in claim 1, wherein the second outlet (6) is rotatably connected to the fitting member (2) via an annular shoulder which is formed concentrically around the first outlet (3).

9. The water outlet fitting as claimed in claim 1, wherein the valve insert (5) comprises a mixing valve, the at least one water supply comprises a hot water supply (4b) and a cold water supply (4a) which lead to the mixing valve (5), and the first waterway guides mixed water from the mixing valve (5) and the second waterway branches directly off from the cold water supply (4a) and guides cold water.

10. The water outlet fitting as claimed in claim 1, further comprising an electronic counter device (13) integrated in the filter housing (7), and an optical display (14) arranged on the filter housing (7) which is connected to the counter device (13) and which displays a functional state of a filter (12) inserted in the filter housing (7).

11. The water outlet fitting as claimed in claim 10, wherein the counter device (13) comprises at least one of a timer or a throughflow meter.

12. The water outlet fitting as claimed in claim 1, wherein the mouth opening (8a) receives a mouthpiece (15) which is arranged on the filter and from which filtered water is discharged from the filter (12).

13. The water outlet fitting as claimed in claim 12, wherein the mouthpiece (12) which is arranged on the filter (12) is sealed in a sterile manner in a delivery state by a tear-off film.

14. The water outlet fitting as claimed in claim 12, wherein the mouthpiece (15) contains an integrated jet controller (16).
